(19) United States
(12) Patent Application Publication
(10) Pub. No.: US 2003/0158076 A1
(43) Pub. Date: Aug. 21, 2003

(54) Amide polymers for use in surface protecting formulations

(76) Inventor: Klein A. Rodrigues, Signal Mountain, TN (US)

Correspondence Address: Thomas F. Roland, NATIONAL STARCH AND CHEMICAL COMPANY, P.O. Box 6500, Bridgewater, NJ, 08807-0500, US

(21) Appl. No.: 10/072,403

(22) Filed: Feb. 8, 2002

(51) Int. Cl. C11D 3/37

(52) U.S. Cl. 510/475

(57) ABSTRACT

The present invention relates to a surface protection composition comprising a polymer having at least one amide monomer unit, where the amide monomers are free of amine linkages. The invention is also directed to a substrate coated with the solution copolymer. Surfaces that benefit from the protection provided by a coating with the amide polymer include wood, metal, fabrics, textiles, hard surfaces, glass, ceramics, leather, hair and skin. The polymer coating helps prevent fading, and wear, provides UV protection, gives anti-pilling protection and anti-wrinkle in laundry detergent and fabric softener applications, and also provides a vehicle for the controlled release of actives. It is especially useful in protecting hard-surfaces such as glass, ceramic, and tiles.

### FIELD OF THE INVENTION

This invention relates to copolymers having amide functionality, used to protect the surface of a substrate. The amide functionality aids in attracting the polymer to a surface. Once associated with the surface, the copolymer forms a protective barrier. The copolymer also aids in anti-spotting properties in dishwashing, aids in color-protection and anti-fading in a laundry wash cycle, and aids in anti-shrinking and shape retention (anti-wrinkling) in a detergent, fabric softener, or spray application, serves as a anti-corrosion barrier on metal, as a moistuerizing aid in personal care applications, and many other similar uses

### BACKGROUND OF THE INVENTION

Detergents, and rinse aids contain additives that provide useful properties to the laundry or dishes. One such additive is linear polyamines that are used in laundry detergent applications to impart fabric appearance benefits and integrity to fabrics and textiles. The use of polyamines for this application is described in WO 99/14297, and WO 00/49124. U.S. Pat. No. 6,140,292 describes a polyamide-polyamine copolymer for fabric treatment. The cationic nature of the amines in the wash environment contributes to an attraction of the polymers to the anionic surface of clothing. These additives are described as associating themselves with the fibers of the fabrics and textiles, and thereby reducing the tendency of the fibers to deteriorate in appearance during laundering.

WO 00/56849 discloses a laundry detergent composition having cationically charged polymers. The polymers are amine-containing homopolymers, copolymers, or the quaternized derivatives. The objective of this application is to maximize the cationic component of the polymer, to increase the association between the polymer and the fibers of fabrics. Amine-functional polymers are disclosed for use in hydrophobically modified solution polymers useful in surface protecting formulations in U.S. patent application Ser. No. 09/920,498.

Unfortunately, because of their cationic nature, amine functional polymers tend to adversely affect detergent properties such as detergency, anti-deposition, and related cleaning properties.

Surprisingly it has been found that amide-functional polymers are attracted to substrate surfaces, serving to protect those surfaces, yet don't have the downsides associated with the amine polymers. While not being bound by any particular theory, it is believed that many surfaces have a weakly acidic character, and the pair of free electrons on the nitrogen of the amine forms an attraction with the slightly acid surface. This is especially true for substituted amides, which increase the basic character of the nitrogen.

### SUMMARY OF THE INVENTION

The present invention is directed to a surface protection composition comprising an amide-functional polymer and to a substrate having associated with its surface the amide-functional polymer. The amide monomers are free of amine linkages in the side chains. The amide polymer forms a protective layer on at least one surface of a substrate, preventing degradation of the surface from environmental forces such as abrasion, corrosion, and radiation

### DETAILED DESCRIPTION OF THE INVENTION

The present invention relates to an amide polymer useful in protecting the surface of many different substrates.

The amide polymers of the present invention may be homopolymers, copolymers or terpolymers. The amide-functional monomer may have the amide functionality on the polymer backbone, in side chains, or a combination thereof.

Amide monomers useful in the present invention are those not having an amine linkage in the side chain. While any polymerizable amide-functional monomer may be used, substituted amides are preferred. Substituted amines are known to push the electron balance toward the amide nitrogen, making it slightly more basic. Mono- and di-substituted amides, and especially mono-alkyl amide, mono-alkyl acrylamide, N,N,dialkyl acrylamide, and N,N,dialkyl amide are particularly preferred. Preferred amide monomers are N,N dimethylacrylamide, N,N diethylacrylamide, N-isopropylacrylamide and acryloyl morpholin. A mixture of amide monomers may be used. A polymer that is 100 percent amide monomer(s), or an amide homopolymer are particularly preferred from a performance standpoint. However, the inclusion of other monomers can result is a less expensive polymer, and provides a means of introducing other functional moieties into the polymer, that can enhance performance properties. The amide-functional portion of the polymer aids in associating the polymer with a substrate surface, and the functionality provided by other monomers may then provide additional chemical or physical characteristics to the surface. The amide monomer(s) make up at least 1 mole percent of the polymer, preferably at least 5 mole percent, more preferably at least 10 mole percent, and most preferably at least 25 mole percent. Amide monomer levels of greater than 40 mole percent, greater than 50 mole percent and even greater than 75 mole percent may be advantageous in some circumstances, depending on the intended end-use.

Copolymers of amino acids such as a copolymer of aspartic acid and soduim aspartate, as disclosed in U.S. Pat. No. 5,981,691 are useful. These polymers contain an amide functionality in the backbone and are available from Folia as Reactin AS 11. Furthermore, these copolymers have an imide functionality. This imide functionality can be reacted with an amine reagent such as diethanol amine, etc to form a polymer with amide side chains.

The amide polymer can be copolymerized with any other monomer or monomers known in the art. Copolymerization may occur in a dispersion, solution, emulsion, inverse emulsion or other known polymerization techniques. Amides may be copolymerized by free-radical polymerization, and also through addition, condensation and ring-opening polymerization. While any known comonomers may be used, preferred comonomers are those free of amine functionality. The choice of polymerization method can be chosen based on the monomer mixture, and other relevant factors. Polymerization aids, such as solvents, chain transfer agents, initiators, and stabilizers may be used at typical levels.

In one preferred embodiment, the polymer is a copolymer of the amide monomer and at least one hydrophilic monomer. The preferred hydrophilic monomer is a base-neutralizable monomer or mixture of monomers. Examples of these monomers include, but are not limited to, carboxylic, dicarboxylic, sulfonic, and phosphonic acids, such as acrylic acid, methacrylic acid, maleic anhydride, itaconic acid, crotonic acid, styrene sulfonic acid, 2-acrylamido-2-methylpropane sulfonic acid, vinyl sulfonic acid, ethacrylic acid, alpha-chloro-acrylic acid, alpha-cyano acrylic acid, beta methyl-acrylic acid (crotonic acid), alpha-phenyl acrylic acid, sorbic acid, alpha-chloro sorbic acid, angelic acid, cinnamic acid, p-chloro cinnamic acid, beta-styryl acrylic acid (1-carboxy-4-phenyl butadiene-1,3), itaconic acid, maleic acid, citraconic acid, mesaconic acid, glutaconic acid, aconitic acid, fumaric acid, tricarboxy ethylene, 2-acryloxypropionic acid, vinyl sulfonic acid, phosphoric acid, vinyl phosphonic acid, methallyl sulfonic acid, sulfonated styrene, and allyloxybenzenesulfonic acid. Preferably the hydrophilic based-neutralizable monomer is acrylic acid, methacrylic acid, or 2-acrylamido-2-methylpropane sulfonic acid. Preferably, the acid monomer is at least partially neutralized, either before of after polymerization. Thus, for example sodium 2-acrylamdo-2-methylpropane sulfonic acid may be used as the monomer, or the copolymer may be neutralized after polymerization by volatile or non-volatile bases.

In another embodiment, the amide monomer(s) are polymerized with one or more hydrophobic ethylenically unsaturated monomers. Examples of such monomers include, but are not limited to: (meth)acrylates, maleates, (meth)acrylamides, vinyl esters, itaconates, styrenics, unsaturated hydrocarbons and acrylonitrile, nitrogen functional monomers, vinyl esters, alcohol functional monomers, unsaturated hydrocarbons, and (meth)acrylates. Preferred hydrophobic monomers are vinyl monomers and acrylate monomers such as methyl methacrylate, butyl acrylate. To maintain water-solubility of the copolymer, hydrophobic monomers preferably make up less than 50 mole percent of the copolymer, and more preferably less than 30 mole percent.

In still another embodiment the amide monomers may be copolymerized with acid neutralizable monomers, providing these monomers do not contain amide groups.

The polymers formed are generally random copolymers. However, other polymer architectures such as block, star etc may also be used. The special techniques used to synthesize these various types of polymer architecture are well known in the art.

If the copolymer is formed by solution polymerization it may take place in water if the monomers are sufficiently hydrophilic, or if the monomers are more hydrophilic the polymerization may take place in other solvent, followed by a solvent exchange to produce an aqueous-based product. One method for performing this type of polymerization is described in U.S. patent application Ser. No. 09/690,387, incorporated herein by reference. The aqueous polymer composition formed in this manner is a solution or dispersion having essentially no stabilizing surfactants, as opposed to a latex or emulsion polymer composition. The advantage of having an aqueous polymer composition is ease of handling and ease of formulating the polymers into various applications.

The amide functional polymer is useful in a variety of formulations, and on a variety of substrates. Substrates that may be protected by the amide polymers include, but are not limited to, glass, metal, wood, ceramic, plastics, vinyl, textile, fabric, dishware, silverware, flooring, tile, concrete, leather, paper, fiber-board, carpet, paper, cardboard, upholstery, and non-wovens,

The amide polymer may be formulated with one or more other ingredients into a final composition to provide surface protection. The amide-polymer containing composition may be an aqueous liquid, a non-aqueous liquid such as alcohol or glycol-based, a gel, a dry powder, or other known forms. The polymer is added into a formulation in any manner known in the applicable art. Formulations having the polymer contain from 0.00001 to 50 percent by weight, preferably from 0.01 to 40 percent by weight of the polymer, based on the weight of the formulation, and most preferably from 0.1 to 20 percent by weight of the polymer on a solids/solids basis. The other ingredient include, but are not limited to: surfactants, builders, ion exchangers, alkalies, anticorrosion materials, antiredeposition materials, optical brighteners, fragrances, dyes, chelating agents, enzymes, whiteners, brighteners, antistatic agents, sudsing control agents, solvents, hydrotropes, bleaching agents, perfumes, bleach precursors, water, buffering agents, soil removal agents, soil release agents, softening agents, opacifiers, inert diluents, buffering agents, corrosion inhibitors, graying inhibitors, stabilizers, acids and bases (for hard surface cleaning) anti-microbial agents, and fungicides.

The thickness of the polymer film on the substrate depends on the end use application. In the case of metal and wood protection in outdoor applications, the thicker the film (millimeter thickness) the better the properties. However, in some cases, such as detergent and fabric softener applications, the polymer is used in such small amounts (parts per million level) in the aqueous wash bath, that any film if formed would be on a microscopic level (nanometer thickness). Nevertheless, the polymer is still effective as evidenced by properties illustrated in the examples.

For illustration purposes, some of the formulations and uses of the amide polymers are listed and exemplified below. A practitioner in the art will recognize from these few illustrations many other uses and formulations in which these surface-protective polymers may be used.

The polymer composition may be used as a coating to protect a variety of finishes such as automobiles, paint on the outside of building, roof tiles, and as coatings on a variety of materials that need to resist the environment.

Typically oily films are applied to metallic parts to prevent corrosion during transport. The metallic parts are then cleaned with solvents to remove the oily finish before they are painted. The polymers of this invention overcome this environmentally unfriendly process because, they can be delivered from an aqueous solution, can then be removed by an aqueous solution if needed. However, they need not be removed and can be directly painted over saving time money and the environment. Moreover, by adjusting the glass transition temperature of the polymer the film can be designed to be stiff or flexible and therefore can adhere to a variety of metal surfaces such as stainless steel, mild steel, copper brass tin aluminum, cast iron etc.

Metal corrosion and scale formation are problems in applications involving constant water contact—such as in a boiler or water treatment. The amide polymer will associate with the metal to form a protective film. Additionally, amide copolymers containing anionic monomers such as AMPS, or (meth)acrylic acid, can interfere with scale formation, and thus reduce scale, or change the crystalline make-up of the scale to one that is more easily removable.

Formulations made with the polymer composition of this invention are useful in metal working fluids. The polymer can be incorporated into these formulations and provide a protective film to the newly cut surface while the metal is being cut.

While formulations of the present invention are very useful in a variety of coating applications, their usefulness extends beyond conventional coatings. The amide polymers may be formulated into detergents and fabric softeners. The amide polymers are then introduced in to the laundering process during the wash and or rinse cycle, and provide color protection, pill reduction and anti-wrinkle properties to fabrics thus treated. Furthermore, they may be used to deliver actives such as perfumes and enzymes, silicones, and water-soluble additives such as sugars from a detergent or fabric softener formulation through the wash or rinse liquor. The polymers could be used to deliver anti-wrinkle benefits in spray applications. These benefits may be with or without ironing.

The amide copolymers are useful in autodish formulations to minimize filming and spotting and enhance the performance of rinse aids in the rinse cycle.

In textile finishing applications the polymers may be applied in the finishing step along with cationic softeners to minimize abrasion and loss of dyes during subsequent laundering, and wear and tear during use. The polymer composition is also useful in preventing backstaining of denim during the stonewashing process. In a fabric softener, the polymer serves as an anti-wrinkling and shape-retention aid.

The amide polymers could also be applied to carpets, textiles and fabrics through a spray application. In one application, the amide polymer could be copolymerized with a known water-absorbing monomer, such as hydroxy alkyl urea, and applied to a textile or fabric as an anti-wrinkle agent.

In a similar manner, water-absorbing monomers can be copolymerized with the amides for use as humunculants in personal care applications where moisturizing is desired.

In some applications, such as in a car wash, the polymer composition can be adjusted to provide a protective coating to the car surface, yet dissolve in the next wash removing built-up dirt.

The polymer composition of the present invention can be formulated and applied to a fabric as a fabric finish during the textile processing application. Fabric thus coated is found to exhibit anti-pilling properties. Fabrics treated with the coating composition also resist fading and this treatment can last several washes.

The polymer composition is useful as a dispersant, which can be used in many formulations, such as those used to treat textiles. The materials dispersed may be dyes, pigments, clays, dirt, soils minerals and other hard to disperse moeities.

Amide copolymers can associate with hard surfaces, such as tile, ceramics, flooring and glass. On glass, the amide copolymer could also be useful when formulated as a water-soluble adhesive. The amide-surface association helps overcome the problem of good adhesion to glass found in many adhesives.

The polymer compositions of the present invention may also be used a water barriers in paper and board coating applications. The polymer further serves as a coating to protect dyes from abrasive rub-off.

The polymer compositions may be used to disperse hydrophobic materials such as clays, perfumes, etc. into aqueous systems. They may be used in mining applications to disperse ores.

The polymers of this invention may also be used in personal care applications. A specific application that base neutralizable polymers of this invention are extremely suited to are sun screen formulations with UV protection. When formulated with hydrophobic monomers, the amide copolymer will form a water-resistant film on the skin and prevent the UV protection agents from being washed off. However, the polymeric film may be removed by the alkaline cleaning agents in bar soaps when the person showers.

The amide polymers, especially those of substituted amines, tend to have a large capacity for water retention. While not being bound by any given theory, it is believed that the substitution pushes electrons towards the N making the lone pair of electrons more available for hydrogen bonding with water, cellulose and other similar substances. Preferred polymers for this purpose are those at very high molecular weights. These substituted amine polymers are useful as humectants, and can be formulated into skin creams, lotions and other personal care products. The polymers are also useful as moisture retention aids in agricultural applications.

The polymer composition of the invention may also be used in agricultural applications to coat actives like fertilizers and seeds. The coated actives can be introduced into the soil and the actives released over a period of time. The time period of release can be controlled by the pH range of the soil, the ratio of hydrophobe to hydrophilic monomer in the polymer, the amount of neutralization and the ratio of volatile to non-volatile neutralization agent.

The polymer composition may also be used to prolong the effect of insect repellants and biocide/anti-microbials in spray applications.

In concrete and cement applications, the amide copolymers could be added as super-plasticizers to increase the strength of the finished material.

Some non-aqueous uses of the amide copolymer include ink jet printing, dry cleaning applications, and in mineral dispersant applications.

The following examples are presented to further illustrate and explain the present invention and should not be taken as limiting in any regard.

Unless indicated otherwise, all percentages are in mole percent.

### EXAMPLE 1

Copolymer of N,N dimethylacrylamide and acrylic acid.

To a 1 litre glass vessel equipped with; reflux condenser, stirrer, means of temperature control, 300 g water was charged then heated to 85 C. A monomer mixture of N,N dimethylacrylamide available from Kohjin in Japan (150.0 g) and acrylic acid (50 g) was fed into the reactor over an approximate timeframe of 2 hours. Sodium persulfate solution (4.5 g in 80 g of water) was fed concurrently with the monomer over 2.5 hours. 1. 6 g of 3-mercaptopropanol dissolved in 40 g water was fed concurrently over a period of 1.5 hours. The reaction mixture was then heated for 2 hours at 85C. The final product was partially neutralized using 13.0 grams of 50% NaOH and was a clear light yellow solution.

### EXAMPLE 2

Copolymer of N,N dimethylacrylamide and methacrylic acid.

To a 1 litre glass vessel equipped with; reflux condenser, stirrer, means of temperature control, 300 g water was charged then heated to 85C. A monomer mixture of N,N dimethylacrylamide available from Kohjin in Japan (150.0 g) and methacrylic acid (50 g) was fed into the reactor over an approximate timeframe of 2.5 hours. Sodium persulfate solution (4.5 g in 80 g of water) was fed concurrently with the monomer over 2 hours and 45 minutes. 1.9 g of 3-mercaptopropanol dissolved in 40 g water was fed concurrently over a period of 2.0 hours. The reaction mixture was then heated for 2 hours at 85C. The final product was partially neutralized using 13.0 grams of 50% NaOH and was a clear light amber solution.

### EXAMPLE 3

Copolymer of N,N dimethylacrylamide and Na AMPS (sodium 2-acrylamido, 2-methyl propane sulfonate).

To a 1 litre glass vessel equipped with; reflux condenser, stirrer, means of temperature control, 250 g water was charged then heated to 85C. A monomer mixture of N,N dimethylacrylamide available from Kohjin in Japan (150.0 g) and a 50% solution sodium AMPS available from Lubrizol (100 g) was fed into the reactor over an approximate timeframe of 2.5 hours. Sodium persulfate solution (4.5 g in 80 g of water) was fed concurrently with the monomer over 3 hours. 1.5 g of 3-mercaptopropanol dissolved in 40 g water was fed concurrently over a period of 2 hours. The reaction mixture was then heated for 2 hours at 85C. The final product was a clear light yellow solution.

### EXAMPLE 4

Copolymer of N,N,dimethylacrylamide and methylmethacrylate.

To a 500 ml glass vessel equipped with; reflux condenser, stirrer, means of temperature control, 200 g water and 100 grams of isopropanol was charged then heated to 85C. A monomer mixture of N,N dimethylacrylamide available from Kohjin in Japan (70.0 g) and methylmethacrylate (30.0 g) was fed into the reactor over an approximate timeframe of 1.25 hours. Sodium persulfate solution (1.0 g in 30 g of water) was fed concurrently with the monomer over 1.5 hours. The reaction mixture was then heated for 2 hours at 85C. The isopropanol was then distilled to produce a nearly aqueous polymer solution.

### EXAMPLE 5

Homopolymer of acryloyl morpholin (substituted cyclic amide).

To a 500 ml glass vessel equipped with; reflux condenser, stirrer, means of temperature control, 100 g was charged then heated to 80C. A monomer feed of 100 grams of acryloyl morpholin available from Kohjin in Japan was fed into the reactor over an approximate timeframe of 1.5 hours. Sodium persulfate solution (4.0 g in 22 g of water) was fed concurrently with the monomer over 2 hours. 1.0 g of 3-mercaptopropanol dissolved in 24 g water was fed concurrently over a period of 1.5 hours. The reaction mixture was then heated for 2 hours at 80C.

### EXAMPLE 6

Ring opening polymer of 2-methyl-2-oxazoline.

2-methyl-2-oxazoline may be polymerized using cationic initiators to give a homopolymer. This polymer (poly(N-acetylethyleneimine) is available from Jarchem industries as Jaracryl P2E20. This polymer is an example of a disubstituted amide in the backbone.

### EXAMPLE 7

Copolymer of N,N dimethylacrylamide and hydroxy ethylacrylate.

To a 1 litre glass vessel equipped with; reflux condenser, stirrer, means of temperature control, 300 g water was charged then heated to 85C. A monomer mixture of N,N dimethylacrylamide available from Kohjin in Japan (150.0 g) and hydroxyethyl acrylate (50 g) was fed into the reactor over an approximate timeframe of 2.5 hours. Sodium persulfate solution (4.5 g in 80 g of water) was fed concurrently with the monomer over 2 hours and 45 minutes. 4.0 g of 3-mercaptopropanol dissolved in 40 g water was fed concurrently over a period of 2.0 hours. The reaction mixture was then heated for 2 hours at 85C.

### EXAMPLE 8

Copolymer of acrylamide and acrylic acid.

To a 2 litre glass vessel equipped with; reflux condenser, stirrer, means of temperature control, 1162 g water was charged then heated to 75C. A steady stream of Nitrogen was bubbled through the solution. A monomer mixture of 21.7 grams of acrylic acid and 688 grams of a 50% solution of acrylamide was fed into the reactor over an approximate timeframe of 3.0 hours. Sodium persulfate solution (0.75 g in 147 g of water) was fed concurrently with the monomer over 3 hours and 20 minutes. 2.3 g of a 41% solution of sodium bisulfite dissolved in 147 g water was fed concurrently over a period of 3.0 hours and 20 minutes. The reaction mixture was then heated for 2 hours at 75C.

### EXAMPLE 9

Anti Wrinkle

The polymers of Example 1 and 3 were tested for anti-wrinkle properties in the main wash. All additives were added separately over the side to the washing machine. The polymers were dosed at 2 weight percent active based on weight of the detergent. The tests were conducted in a full-scale washing machine over 2 cycles, but no drying in between. The detergent used was 58 g Tide powder and the water was Chattanooga City water with a typical hardness of 70 ppm as CaCO₃. The test swatches were 5-10″×10″ prewashed TIC 400 bleached print cloth. 12 ballast pillowcases and 3 ballast towels were used as ballast. The test used a 10-minute wash @ 93° F. The swatches were then hung up to air dry. The swatches were then evaluated visually using the following scale: 1—same or worse than the control, 2—slightly better than the control, 3 —better than the control, 4—much better than the control.

| Polymer | Anti-wrinkle performance rating |
|---|---|
| Example 1 | 4 |
| Example 3 | 4 |

The data indicate that these polymers have excellent anti-wrinkle performance even in a difficult medium such as the main wash.

### EXAMPLE 10

Hard Surface Cleaning Data

Black ceramic tiles were cleaned with a soap solution and then rinsed with acetone and let dry. The tiles were then sprayed with a 1% polymer film in 25% isopropanol and 75% water. The tiles were then dried and then dipped in a soap scum solution which contained 2% Ca oleate. The tiles were then rinsed in hard water (250 ppm as CaCO₃, Ca:Mg is 3:1). This process was repeated for 5 cycles.

| Polymer | Cleaning performance |
|---|---|
| Example 1 | Much Cleaner than the control |
| Example 6 | Cleaner than the control |

### EXAMPLE 11

Personal Care Formulation

Water repellant sunscreen

| Ingredients | Wt % |
|---|---|
| Glycerin | 5.0 |
| Polymer of Example 5 | 2.0 |
| PEG 100 stearate | 5.0 |
| Isostearyl stearate | 4.0 |
| Octyl methoxycinnamate | 7.5 |
| Butyl methoxydibenzoylmethane | 1.5 |
| Hexyl methicone | 5.0 |
| DI water | rest |

### EXAMPLE 12

Textile Application

The polymer of Example 7 was padded on to cotton fabric during the textile finishing process. The weight of the polymer put on to the fabric was 1 weight percent by weight of the fabric. The treated and finished fabric was then run through 25 cycles of a regular washing machine. The treated fabric exhibited less dye loss and wear and tear as compared to an untreated fabric.

### EXAMPLE 13

Typical Hard Surface Cleaning Formulations

| Ingredient | wt % |
|---|---|
| Acid Cleaner | |
| Citric acid (50% solution) | 12.0 |
| C12-15 linear alcohol ethoxylate with 3 moles of EO | 5.0 |
| Alkylbenzene sulfonic acid | 3.0 |
| Polymer of Example 2 | 1.0 |
| Water | |
| Alkaline Cleaner | |
| Water | 89.0 |
| Sodium tripolyphosphate | 2.0 |
| Sodium silicate | 1.9 |
| NaOH (50%) | 0.1 |
| Dipropylene glycol monomethyl ether | 5.0 |
| Octyl polyethoxyethanol, 12-13 moles EO | 1.0 |
| Polymer of example 3 | 1.0 |

### EXAMPLE 14

Typical Automatic Dishwash Formulation

| Ingredients | Amounts |
|---|---|
| Sodium tripolyphosphate | 25.0 |
| Sodium carbonate | 25.0 |
| C12-15 linear alcohol ethoxylate with 7 moles of EO | 3.0 |
| Polymer of Example 3 | 4.0 |
| Sodium sulfate | rest |

### EXAMPLE 15

Car Wash Rinse Off Aid Formulation

| Ingredients | wt % |
|---|---|
| Water | 80 |
| Butyldiglycol | 10 |
| Polymer of Example 6 | 10 |

### EXAMPLE 16

Metal Protection

Mild steel coupons were cleaned with xylene and then dried them with acetone. Directly following this cleaning step, solutions of the polymer compositions of Examples 1 and 3 at 3% were sprayed onto the coupons, and the coupons were dried overnight. The next day the coupons were place in a tap water bath at room temperature and allowed to soak for several hours. The coupon treated with the polymer of Example 1 was far less corroded than a control coupon and the coupon treated with the polymer of Example 3 was less corroded than the control coupon.

### EXAMPLE 17

Typical Fabric Softener Composition

TABLE 1
Formulations of Dilute Traditional Softeners (Single Active)^{a}
Formula A

| Ingredient | (%) |
|---|---|
| distearyldimethylammonium Chloride | 6-9 |
| (75% active) | 0.1-3.0 |
| Polymer of Example 6 | 0.2-0.5 |
| Perfume | 0.001 |
| Colorant | Balance |
| Water | |

### EXAMPLE 18

Wrinkle Reducing Spray.

Wrinkle Release Method

Shirts were first prewashed in Tide powder and dried in the drier. Each shirt was then placed on a flat surface and one side was covered with paper. The uncovered side was sprayed with the treatment solution A. The treated side was covered and the other side was sprayed with Solution B.

| | wt % |
|---|---|
| Solution A | |
| Polymer of Example 3 (active) | 2 |
| Water | 98 |
| Solution B | |
| Water | 100 |

The paper was then removed and the shirt was pulled taught and smoothed to remove wrinkles. The shirt was then allowed to air dry.

Visual examination of the shirt indicated that the polymer of example 3 of this invention is superior to water and exhibited less wrinkles.

What is claimed is:

1. A polymer-treated substrate comprising a substrate having associated thereon a polymer composition comprising a polymer having at least one mole percent of one or more amide monomer units, wherein said amide monomer(s) is free of amine linkages in the side chains.

2. The polymer-treated substrate of claim 1 wherein said amide monomer has at least one amide moiety in the polymer backbone, in the polymer side chains, or a combination thereof.

3. The polymer-treated substrate of claim 2, wherein when the amide moiety is in the side chain then the monomer is free of amine linkages.

4. The polymer-treated substrate of claim 1 wherein said amide is a mono- or di-substituted amide.

5. The polymer-treated substrate of claim 1 wherein said amide comprises N,N dimethylacrylamide, N,N diethylacrylamide, N-isopropylacrylamide, acryloyl morpholin, or a mixture thereof.

6. The polymer-treated substrate of claim 1 wherein said substrate is selected from the group consisting of glass, metal, wood, ceramic, plastic, textile, fabric, leather, fiber glass, cement, dishware, silverware, flooring, tile, concrete, paper, and fiber-board.

7. The polymer-treated substrate of claim 1 wherein said polymer composition comprises at least 30 percent by weight of water.

8. The polymer-treated substrate of claim 1 wherein said polymer is an amide homopolymer.

9. The polymer-treated substrate of claim 1 wherein said polymer comprises at least 5 mole percent of one or more amide monomer units.

10. The polymer-treated substrate of claim 9 wherein said polymer is a copolymer comprising at least 10 mole percent of one or more amide monomer units.

11. The polymer-treated substrate of claim 10 wherein said polymer comprises at least 25 mole percent of one or more amide monomer units.

12. The polymer-treated substrate of claim 11 wherein said polymer comprises at least 40 mole percent of one or more amide monomer units.

13. The polymer-treated substrate of claim 12 wherein said polymer comprises at least 50 mole percent of one or more amide monomer units.

14. The polymer-treated substrate of claim 13 wherein said polymer comprises at least 60 mole percent of one or more amide monomer units.

15. The polymer-treated substrate of claim 14 wherein said polymer comprises at least 25 mole percent of one or more non-amide monomer(s).

16. The polymer-treated substrate of claim 1 wherein said polymer comprises at least one anionic monomer.

17. The polymer-treated substrate of claim 16 wherein said anionic monomer is selected from the group consisting of carboxylic acids, di-carboxylic acids, sulfonic acids and phosphonic acids.

18. The polymer-treated substrate of claim 1 wherein said polymer comprises from 1 to 50 mole percent of one or more hydrophobic monomers.

19. The polymer-treated substrate of claim 1 wherein said polymer comprises from 0.1 to 20 mole percent of at least one hydroxy alkyl urea monomer.

20. The polymer-treated substrate of claim 1 wherein said polymer composition further comprises from 5 to 70 percent by weight of at least one surfactant.

21. The polymer-treated substrate of claim 1 wherein said polymer composition further comprises one or more ingredients from the group consisting of surfactants, builders, ion exchangers, alkalies, anticorrosion materials, antiredeposition materials, optical brighteners, fragrances, dyes, chelating agents, enzymes, whiteners, brighteners, antistatic agents, sudsing control agents, solvents, hydrotropes, bleaching agents, perfumes, bleach precursors, water, buffering agents, soil removal agents, soil release agents, softening agents, opacifiers, inert diluents, buffering agents, corrosion inhibitors, graying inhibitors, stabilizers, humectants, anti-microbial agents, and fungicides.

22. A method to protect a substrate from environmental factors comprising:
a) forming a protective composition comprising a polymer composition, said polymer composition comprising a polymer having at least one mole percent of one or more amide monomer units, wherein said amide monomer(s) is free of amine linkages; and
b) contacting said protective composition with a substrate.

23. The method of claim 22, wherein said protective composition is applied to said substrate by means of spray, immersion, brushing.

24. The method of claim 22 wherein said protective composition is aqueous-based.

25. The method of claim 22 wherein said protective composition is formulated as a laundry detergent, a dishwasher detergent, a fabric softener, a rinse aid, an anti-wrinkle spray, a hard-surface cleaner/disinfectant, a personal care product, a water-treatment, a concrete additive, or a metal-working fluid.
